(19) United States
(12) Patent Application Publication
(10) Pub. No.: US 2015/0122805 A1
(43) Pub. Date: May 7, 2015

(54) MICROWAVE OVEN DOOR SEALS

(71) Applicant: Richards Corporation, Sterling, VA (US)

(72) Inventor: Scott Richards, South Riding, VA (US)

(21) Appl. No.: 14/531,041

(22) Filed: Nov. 3, 2014

Related U.S. Application Data
(60) Provisional application No. 61/898,569, filed on Nov. 1, 2013.

(51) Int. Cl. H05B 6/76

(52) U.S. Cl. CPC H05B 6/763
USPC 219/741

(57) ABSTRACT

Embodiments of the present invention microwave oven door seal configurations that are designed to reduce power leakage of microwave ovens. The concepts provided may find particular use on-board aircraft or other passenger transport vehicles that have various types of communication equipment that operate at a similar frequency as microwave ovens, and for which interference should be reduced or eliminated.

### CROSS REFERENCE TO RELATED APPLICATIONS

This application claims the benefit of U.S. Provisional Application Ser. No. 61/898,569, filed Nov. 1, 2013, titled “Category M Microwave Oven Door Seal,” the entire contents of which are hereby incorporated by reference.

### FIELD OF THE DISCLOSURE

Embodiments of the present disclosure relate generally to microwave oven door seal configurations that are designed to reduce power leakage from microwave ovens. The concepts provided may find particular use on-board aircraft or other passenger transport vehicles that have various types of communication equipment that operate at a similar frequency as microwave ovens, and for which interference should be reduced or eliminated.

### BACKGROUND

In microwave oven design, the ability to prevent microwave energy leakage can be a primary focus. First, leakage should be prevented in order to protect users from exposure to the microwave energy. Second, leakage should be prevented so as not to interfere with communication devices working in the same bands. For example, Wi-Fi and microwave oven manufacturers are required by the Federal Communication Commission (FCC) to operate within any of a finite number of allocated frequency bands. These bands may be referred to as ISM (industrial, scientific, and medical) radio bands. Based on a variety of factors, the band that makes the most sense for Wi-Fi and microwave ovens is the 2.4-2.5 GHz band. This means that the frequency of the microwave oven and the frequency of the LAN (local area network) communication use the same ISM band of 2.45 GHz. The electromagnetic noise generated from the microwave oven can create a potential interference with the wireless LAN communication Wi-Fi equipment, causing communication errors. The powerful emissions of microwave ovens can create electromagnetic interference that disrupts radio communications using the same frequency. This can be a particular problem on-board aircraft, where the need for internet services on-board has increased.

In an effort to provide compatibility between microwave ovens and communication devices operating within the same band, there have been attempts to contain the microwave power to a level that is low enough that it does not cause interference. The Radio Technical Commission for Aeronautics (RTCA) document DO-160 provides emission limits (for all equipment, not specific to microwave ovens) that have been determined to ensure interference free operation between devices. The “Category M” limit is the strictest limit within the 2.4-2.5 GHz frequency range, and allows a field strength of only 68 dBuV/m at a one meter distance from the unit.

Microwave ovens are generally designed to meet a requirement for human safety, which has been defined internationally as a power density of less than 5 mW/cm² at a distance of 5 cm from any point on the unit. That limit, if integrated around the door seal and translated to a one meter distance, and converted from power density to field strength exceeds the Category M limit by many orders of magnitude.

### BRIEF DESCRIPTION OF THE DRAWINGS

FIG. 1 is a side schematic view that shows a multi-stage door seal.

FIG. 2 is a top perspective view of a cavity seal for use with a multi-stage door seal.

FIG. 3 is a side cross-sectional view of the cavity seal of FIG. 2.

FIG. 4 is a top perspective view of a door seal for use with a multi-stage door seal.

FIG. 5 is a side cross-sectional view of the door seal of FIG. 4.

FIGS. 6 and 6A are side cross-sectional views that show a cavity seal and door seal in a partially open position.

FIG. 7 is side cross-sectional view that shows an alternate multi-stage door seal with angled walls.

FIG. 8 is a side cross sectional-view that shows the multi-stage door seal of FIG. 7 in a partially open position.

FIG. 9 is a side cross-sectional view of an alternate multi-stage door seal is an partially open position.

FIG. 10 is a side cross-sectional view of the seal of FIG. 9 in a closed position.

FIG. 11 is a top perspective view that shows the seal of FIGS. 9 and 10 in place on a microwave oven cavity.

FIG. 12 is a top perspective view that shows a close-up view of the seal of FIGS. 9 and 10 in place on a microwave oven cavity.

### DETAILED DESCRIPTION

Measurements of typical microwave ovens confirm that units emitting a power density of less than 1% the maximum safety limit still emit enough power that the field strength at one meter greatly exceeds the Category M limit. In order to reduce the field strength emitted to a level below Category M requires a reduction in power leakage of at least about 50 dB, or 100,000 times.

One of the greatest sealing challenges for designing a microwave for aeronautical use (or other vehicle that should comply with Category M) is the microwave oven door seal. Microwave energy will not transmit through solid metal. However, the door must open and close for placement of food in the cavity. The working parts of the door and its required ease of use (e.g., it must be relatively easy for a user to open and close) add challenges to reducing power leakage by such a great amount.

Some attempted designs have failed because they require extreme door closure force. Such designs often use multiple conductive gaskets. The resulting force that is required to overcome the conductive gaskets is so great that to in order to close the door, power is required from the aircraft. Additionally, because of the door strength required by the high closure forces and because of the multiple, large conductive gaskets, door and the interface flange are heavy, which is undesirable in an aircraft application. Further, the effectiveness of conductive gaskets is dependent upon continuous, low resistance contact. The continuous contact can be rapidly degraded by contamination with food oils, grease, particles, dust, and so forth.

Accordingly, it is desirable to provide a microwave oven door seal that does not rely solely on conductive gaskets. It is also desirable to provide a microwave oven door seal that is lightweight and can be closed without aircraft power.

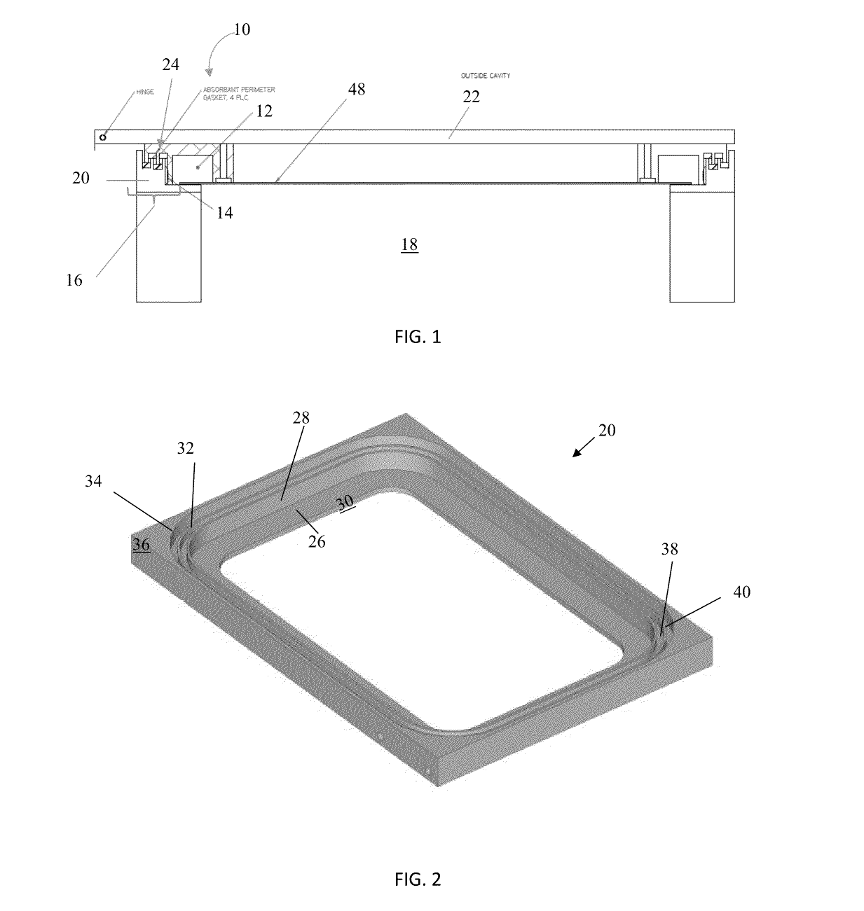

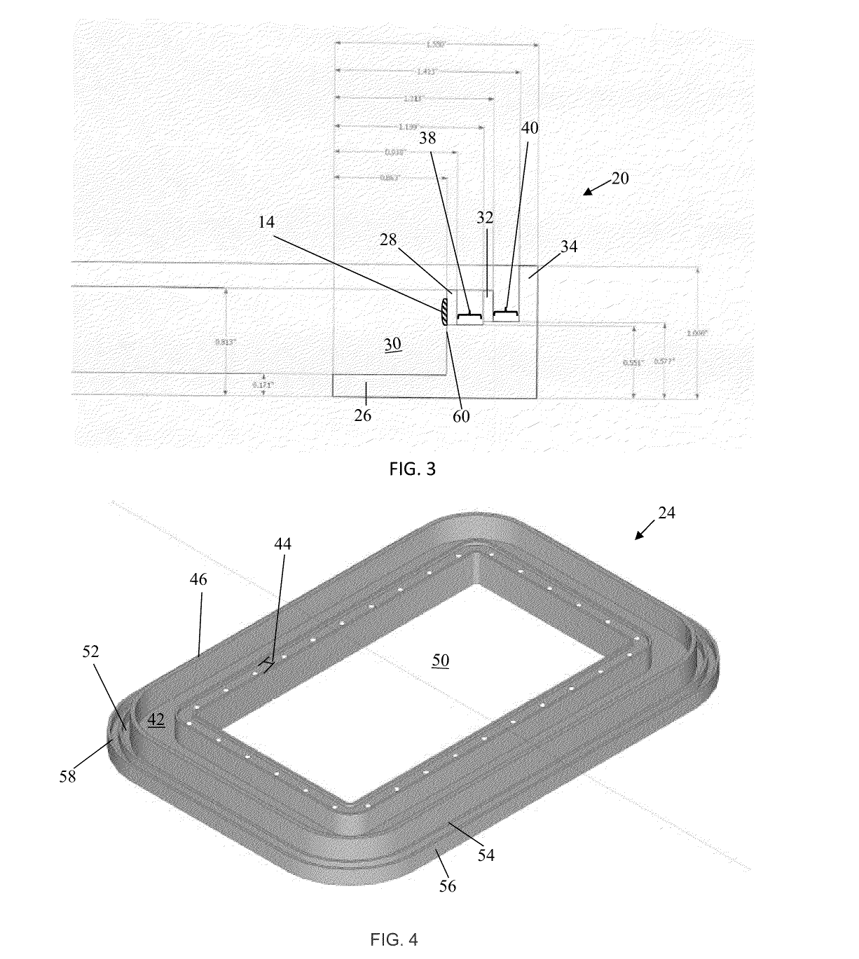

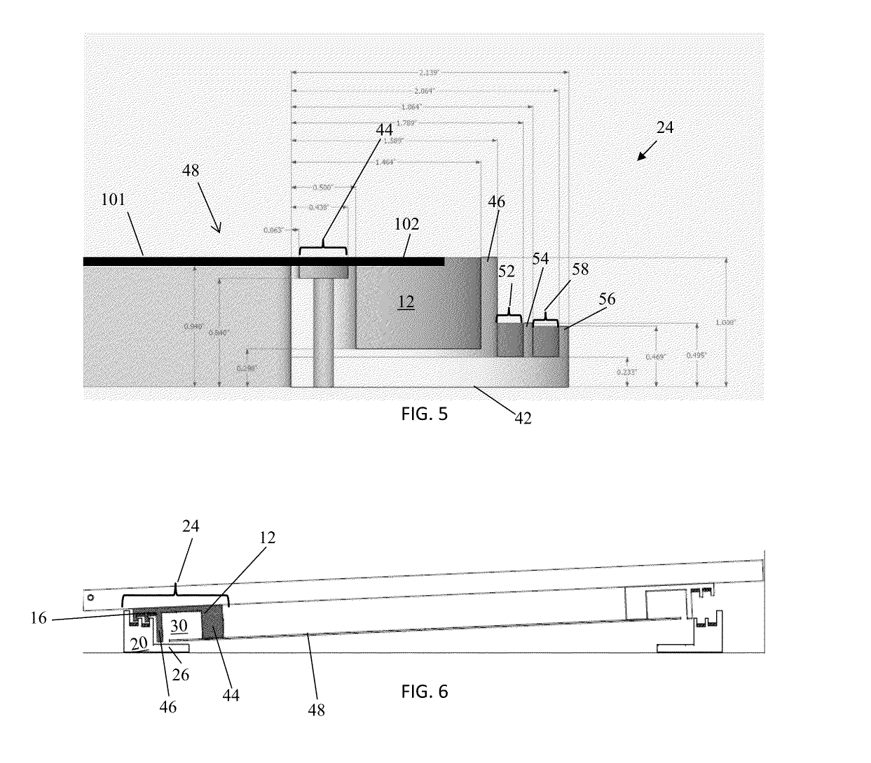

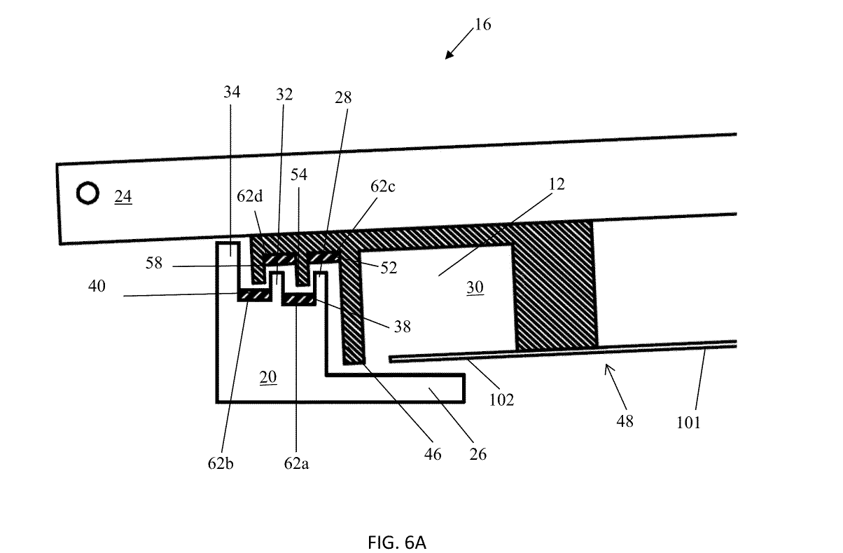

Embodiments of the present disclosure provide a multi-stage door seal 10. The components of the multi-stage door seal 10 include a choke seal 12, a single conductive seal 14, and one or more absorbent material stages 16. Referring now to FIG. 1, there is shown a microwave oven cavity 18 and a cavity seal 20. FIG. 1 also shows a microwave oven door 22 and the related door seal 24. The collective cavity seal 20 and the door seal 24 cooperate with one another so as to form the multi-stage door seal 10. FIGS. 2-3 show a cavity seal 20. FIGS. 4-5 show a door seal 24. FIGS. 1 and 6 show cooperation between the cavity seal 20 and the door seal 24.

Referring now to FIG. 2, the cavity seal 20 has an inner ledge 26 and a first wall 28. Inner ledge 26 and first wall 28 help define a space 30 into which the choke 12 can fit. The cavity seal 20 may also have a second wall 32 and a third wall 34. The second wall 32 may be a stand-alone wall that forms a flange-like structure between first wall 26 and third wall 34. The third wall 34 may be the inner edge of the cavity perimeter 36. A first groove 38 may be formed between the first wall 28 and the second wall 32. A second groove 40 may be formed between the second wall 32 and the third wall 34. These walls and grooves are also shown in the cross-sectional view of FIG. 3. These walls and grooves create a series of bends that microwave energy would have to traverse in order to exit the inner cavity 18 to the outside.

Referring now to FIG. 4, the door seal 24 includes a base 42 that forms front surface of the door. At an inner-most part of the base 42 is a window attachment portion 44. This is the area where an inner plate 48 may be installed. The inner plate may include a center section 101, which may include a window so that the user can view the microwave contents. Alternately, center section 101 may be windowless (blank plate). In either case, plate 48 (with or without window) may extend outward, beyond the attachment portion 44 and form one wall 102 of choke 12. This is the area where a microwave window may be installed so that the user can view the microwave contents.

The door seal 24 may also include a microwave choke 12. The choke 12 is defined in part by a raised wall 46 on the door seal 24 and the base 42 of the door seal 24. As shown in FIGS. 1 and 6, the choke is also defined in part by wall portion 102 the plate 48 that covers the window opening 50 and the inner ledge 26 of the cavity seal 20. Most microwave ovens available in the market have choke structures that attenuate or prevent leakage of microwave energy from the joint between the door and the cavity. The choke seal 12 generally creates a U or box-shaped area 30 where microwave energy may travel. Microwave energy emitted travels along the choke walls and reflects back upon itself, changing its impedance. This can set up an impedance mismatch, which greatly attenuates the perimeter leakage. However, some signal level energy may escape this first choke seal 12. Accordingly, further seal elements are outlined below.

Referring back to the door seal 24 of FIG. 4, adjacent to the raised wall 46 is an inner groove 52. Inner groove 52 is positioned between the raised wall 46 and an inner door flange 54. FIG. 4 also illustrates an outer door flange 56. Between the outer door flange 56 and the inner door flange is an outer groove 58. These flanges and grooves are also shown in the cross-sectional view of FIG. 5. These flanges and grooves create a series of bends that microwave energy would have to traverse in order to exit the inner cavity 18 to the outside.

As shown in FIG. 3, a single conductive gasket seal 14 may be provided on the cavity seal 20. In one example, the conductive gasket seal 14 may be provided along an inner surface 60 of the first wall 28. The conductive gasket seal 14 may be one or more copper fingers that press between the door and the cavity wall in order to create a short circuit and prevent escape of energy. The conductive gasket seal 14 may be an aluminum, steel, or stainless steel strip. The conductive gasket seal 14 may be a conductive fabric wrapped around an open cell foam inner core. The conductive gasket seal 14 may be any other type of conductive gasket seal. It is generally intended that only a single conductive gasket seal be used, as one of the drawbacks of such seals is that they require a good deal of force to open. Using more than one conductive seal can result in a door that requires aircraft power to open or at the very least, requires a great deal of user force. This would not lead to a microwave with an elegant look and feel. However, it has been found that use of a single conductive seal can improve the leakage levels, while requiring only a relatively low closure force.

An absorbent material stage 16 is also provided. FIG. 6A shows a blown up view of the absorbent material stage 16 of FIG. 6. The absorbent material stage 16 may be positioned toward an outer-most edge of both the cavity seal 20 and the door seal 24. However, it should be understood that the various seal options 12, 14, and 16 may have their locations interchanged if desired. The absorbent material stage 16 provides one or more stages of absorbent material 62 arranged within a series of bends. This stage 16 may be formed by features on the cavity seal 20 that cooperate with features on the door seal 24.

As shown in FIG. 6A, in one example, absorbent material 62a may be positioned in the first groove 38 of the cavity seal 20. Absorbent material 62b may be positioned in the second groove 40 of the cavity seal 20. Absorbent material 62c may be positioned in the inner groove 52 of the door seal 24. Absorbent material 62d may be positioned in the outer groove 58 of the door seal 24. Although four stages of absorbent material are shown and described, it should be understood that more or fewer stages may be used. For example, each of the cavity seal 20 and the door seal 24 may have additional walls or flanges, such that additional grooves are created. Alternatively, for example, each of the cavity seal 20 and the door seal 24 may have fewer walls or flanges, such that only one groove in each is created.

The absorbent material stage 16 provides multiple absorbent material components 62 along a convoluted path. The general goal is that the absorbent material stage 16 helps absorb any energy that is not attenuated by the choke 12 or shorted out by the conductive gasket 14 (not shown in FIG. 6A for ease of review). In order for such escaping energy to exit the microwave oven entirely, it must now traverse the series of turns created by described walls, flanges, and grooves. Whatever energy that may escape past the conductive gasket 14 must traverse the first wall 28. However, in order to get past this stage, the energy will face the inner groove 52 with absorbent material 62c. Whatever energy that may escape must traverse the inner door flange 54. In order to get past this stage, the energy will face the first door seal groove 38 with absorbent material 62a. Whatever energy that may escape must traverse the second cavity wall 32. In order to get past this stage, the energy will face the outer groove 58 with absorbent material 62d. Whatever energy that may escape must traverse around the outer door flange 56. In order to get past this stage, the energy will face the second groove 40 with absorbent material 62b. Each time the energy must make a turn, it faces a low angle of incidence. As used herein, this term is used to mean that the angle is close to normal. One intent of the design is to force the angle of the incident wave to be as close to normal as possible. Each time the energy must make a turn, it also contacts the absorbent material 62.

In one example, the absorbent material may be formed of silicone, a natural or synthetic rubber, or any other carrier that can serve as a binder and/or carrier. A ferrite or ferromagnetic material may be embedded within the silicone binder. Any material that has the property to absorb the leakage of energy may be used. Non-limiting examples of materials include but are not limited to alnico, bismanol, chromium oxide, carbon, cobalt, dysprosium, fernico, ferrite (iron or magnet), gadolinium, heusler alloy, iron, magnetite, metglas, MKM steel, neodymium magnet, nickel, permalloy, rare-earth magnet, samarium-cobalt magnet, sendust, suessite, yttrium iron garnet, or any combination thereof.

The absorbent material may be formed as a ring-like gasket that can be wedged within each of the grooves described. The absorbent material gasket may be formed so that it does not extend the full height H of each U-shaped space formed by the grooves. This can allow each groove 38, 40 on the cavity seal 20 to receive a corresponding flange 54, 56 of the door seal 24. This can allow each groove 52, 58 on the door seal 24 to receive a corresponding wall 28, 32 of the cavity seal 20.

As the door 22 is moved from an open position to a closed position as shown in FIGS. 6 and 6A, it can be seen that closure of the door 22 against the cavity opening 18 causes this receiving action to take place. This configuration provides a series of convoluted bends that the energy must traverse in order to escape the microwave oven. Each absorptive material gasket 62 at each bend may reduce the emissions from about 6 dB to about 10 dB.

Escaping power is forced to follow a path that causes it to meet the absorbent material at a low angle of incidence, which maximizes the effectiveness of the material. Additionally, the bends themselves provide some attenuation even without the absorbent material in place.

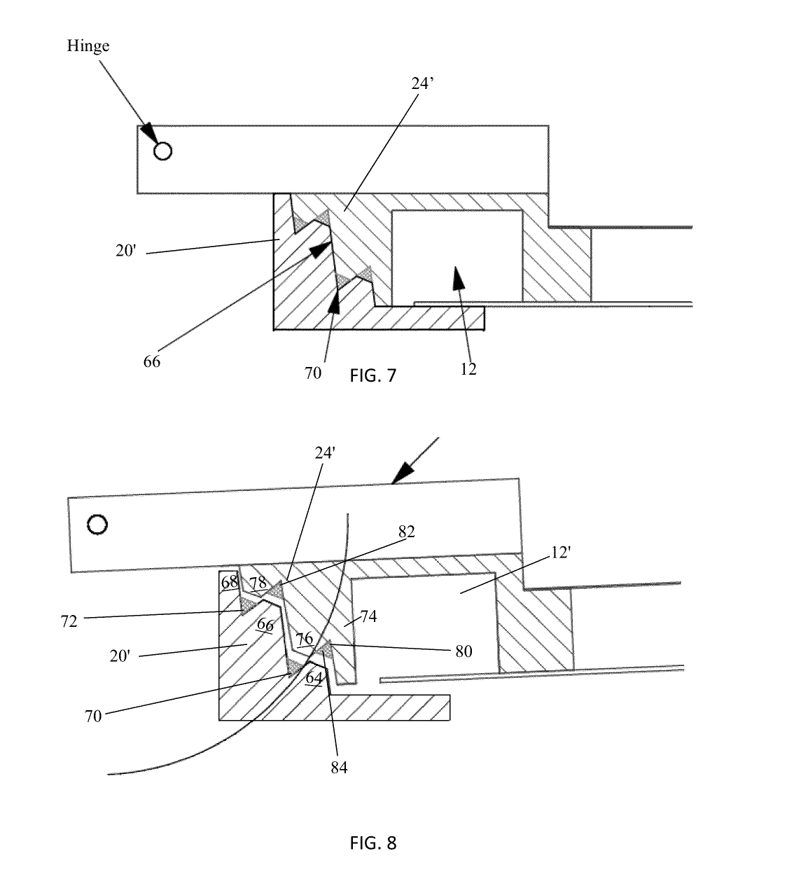

FIG. 7 shows an alternate example with angled walls and flanges. FIG. 8 shows the cavity seal 20′ and the door seal 24′ of this example as they are slightly opened. As shown, the cavity seal 20′ has a first wall 64, a second wall 66, and a cavity perimeter wall 68. Cavity seal 20′ also has first and second grooves 70, 72. In this example, the walls 64 and 66 are angled. This can allow the opening of door to be smoother, without parts of seal portions 20′, 24′ bumping one another. In this example, the grooves 70, 72 are also angled. This can result in a pointed groove area.

Similarly, the door seal 24′ has a choke 12′, a choke wall 74, an inner flange 76, and an outer flange 78. Door seal 24′ also has inner and outer grooves 80, 82. In this example, the flanges 76 and 78 are angled. This can allow the door opening to be smoother, without parts of seal portions 20′, 24′ bumping one another. In this example, the grooves 80, 82 are also angled. This can result in a pointed groove area.

As shown in FIG. 8, when the door seal 24′ is moved toward the cavity seal 20′, a flat upper face of the first wall 64 compresses against an absorbent material 84 positioned in the inner groove 80. Absorbent material 84 is similar in properties and function to the absorbent material 62 described above, with a difference being that absorbent material 84 is shaped to fit into triangular, pointed grooves. (The absorbent material is shown in hatching in this figure; not every instance is numbered.)

This example may provide an even tighter fit due to the angled features provided. Any escaping signal energy must traverse the walls, flanges, grooves, and absorbent material as outlined above. The energy strikes the features at low angles of incidence.

The seals 20, 24 of FIGS. 1-6 may be machined from aluminum. The seals 20′, 24′ of FIGS. 7-8 may be cast as an entire structure, in order to provide the desired angled walls, flanges, and pointed grooves.

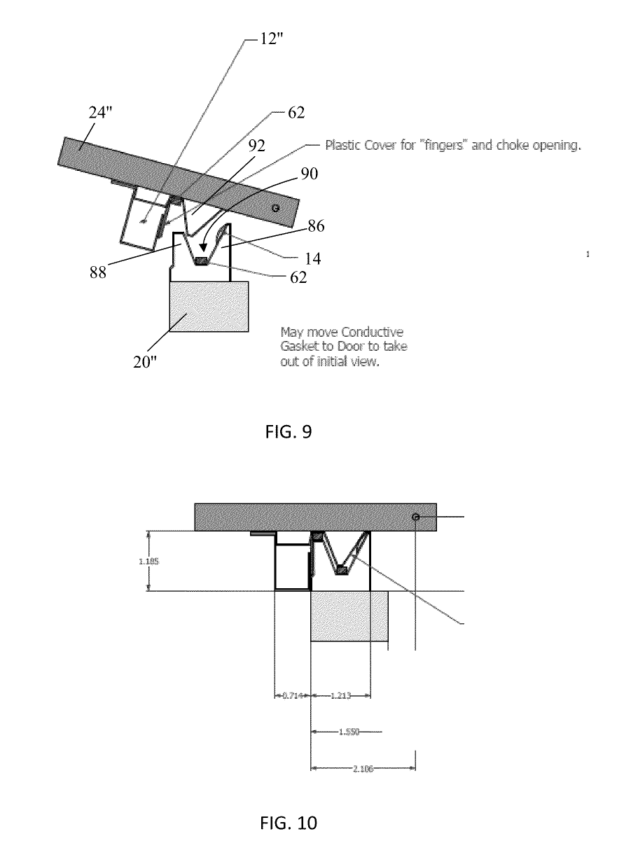

FIG. 9 illustrates an even further example. In FIG. 9, the choke 12″ may be re-oriented sideways on the door seal 24″. This can be beneficial so that the choke 12″ does not encroach on the microwave side, but moves with the door. In this example, the cavity seal 20″ may have first and second walls 86, 88 that form a V-shape 90 therebetween. An absorbent gasket material 62 may be positioned therein. The first wall 86 may also support a conductive gasket 14. This conductive gasket 14, however, may be moved to the door seal.

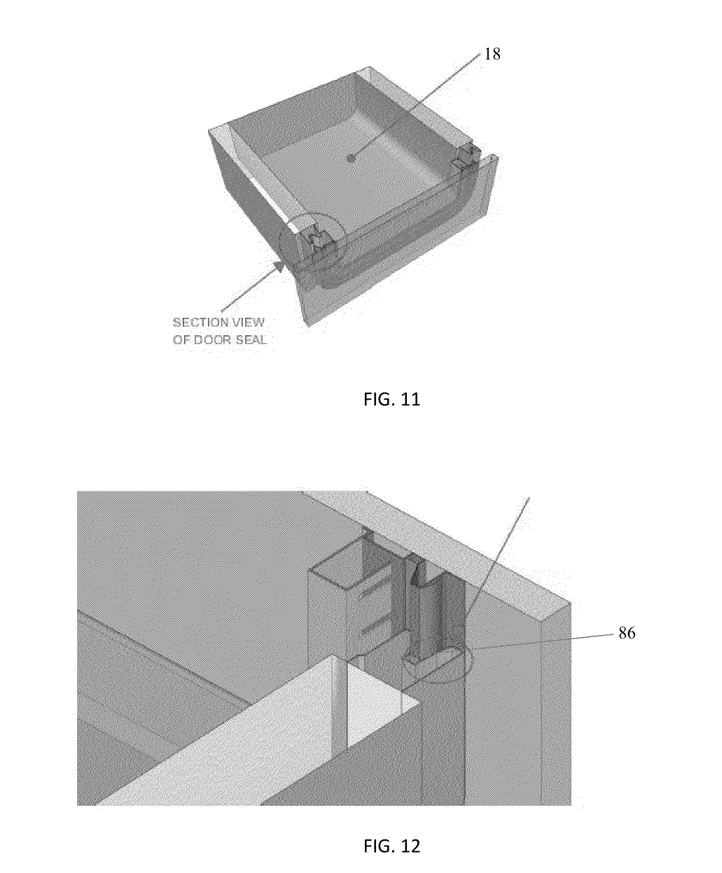

The door seal 24″ may have a flange 92 with angled side walls, such that the flange 92 is received within the V-shape 90. The door seal 24″ may also have an absorbent gasket material 62 positioned such that it is compressed against second wall 88 upon closure of the door seal 24″ against the cavity seal 20″. Again, any escaping energy will be required to traverse the convoluted sequence of bends. Each bend helps reduce unwanted emissions. Each instance of an absorbent gasket material 62 helps reduce unwanted emissions. FIG. 10 shows the door seal 24″ closed against the cavity seal 20″. FIG. 11 shows a top view of a microwave cavity 18 with the seal configurations of FIGS. 9 and 10. FIG. 12 shows a view of the seal configurations in place. The gradual taper of the mating surface (the first wall 86) for the conductive gasket 14 can promote a low closure force.

In some aspects, the microwave seal may be provided according to one or more of the following examples.

### Example 1

A microwave oven door seal, comprising: a cavity seal and a door seal that cooperate with one another; an absorbent material stage comprising (a) the cavity seal comprising a first groove and a second groove, each of the first and second grooves comprising an absorbent material contained therein and (b) the door seal comprising inner groove and an outer groove, each of the inner grooves and outer grooves comprising an absorbent material contained therein.

### Example 2

A microwave oven door seal for an aircraft microwave, comprising: a cavity seal and a door seal that cooperate with one another; a choke seal; an conductive gasket seal; an absorbent material stage seal comprising (a) the cavity seal comprising a first groove and a second groove, each of the first and second grooves comprising an absorbent material of silicone and ferrite contained therein and (b) the door seal comprising inner groove and an outer groove, each of the inner grooves and outer grooves comprising an absorbent material of silicone and ferrite contained therein.

### Example 3

A microwave oven door seal, comprising: a cavity seal and a door seal that cooperate with one another; an absorbent material stage wherein the cavity seal and the door seal form a convoluted series of bends that force any escaping microwave energy to contact the bends at a low angle of incidence; wherein each of the bends comprises an absorbent material associated therewith.

Changes and modifications, additions and deletions may be made to the structures and methods recited above and shown in the drawings without departing from the scope or spirit of the invention and the following claims.

What is claimed is:

1. A microwave oven door seal, comprising:
a cavity seal and a door seal that cooperate with one another;
an absorbent material stage comprising (a) the cavity seal comprising a first groove and a second groove, each of the first and second grooves comprising an absorbent material contained therein and (b) the door seal comprising inner groove and an outer groove, each of the inner grooves and outer grooves comprising an absorbent material contained therein.

2. The seal of claim 1, further comprising a choke seal.

3. The seal of claim 1, further comprising a conductive gasket seal.

4. The seal of claim 1, wherein the absorbent material comprises a silicone material with a ferrite material contained therein.

5. The seal of claim 1, wherein the cavity seal further comprises a (i) first wall and a second wall that define the first groove and (ii) a third wall and the second wall that define the second groove.

6. The seal of claim 5, wherein the door seal further comprises (i) a raised wall and an inner flange that define the inner groove and (ii) an outer flange and the inner flange that define the outer groove.

7. The seal of claim 6, wherein the first wall abuts the absorbent material contained in the inner groove, and wherein the second wall abuts the absorbent material contained in the outer groove when the cavity seal and door seal are closed.

8. The seal of claim 6, wherein the inner flange abuts the absorbent material contained in the first groove, and wherein the outer flange abuts the absorbent material contained in the second groove when the cavity seal and door seal are closed.

9. A microwave oven door seal for an aircraft microwave, comprising:
a cavity seal and a door seal that cooperate with one another;
a choke seal;
an conductive gasket seal;
an absorbent material stage seal comprising (a) the cavity seal comprising a first groove and a second groove, each of the first and second grooves comprising an absorbent material of silicone and ferrite contained therein and (b) the door seal comprising inner groove and an outer groove, each of the inner grooves and outer grooves comprising an absorbent material of silicone and ferrite contained therein.

10. The seal of claim 9, wherein the cavity seal further comprises a (i) first wall and a second wall that define the first groove and (ii) a third wall and the second wall that define the second groove.

11. The seal of claim 10, wherein the door seal further comprises (i) a raised wall and an inner flange that define the inner groove and (ii) an outer flange and the inner flange that define the outer groove.

12. The seal of claim 11, wherein the first wall abuts the absorbent material contained in the inner groove, and wherein the second wall abuts the absorbent material contained in the outer groove when the cavity seal and door seal are closed.

13. The seal of claim 11, wherein the inner flange abuts the absorbent material contained in the first groove, and wherein the outer flange abuts the absorbent material contained in the second groove when the cavity seal and door seal are closed.

14. A microwave oven door seal, comprising:
a cavity seal and a door seal that cooperate with one another;
an absorbent material stage wherein the cavity seal and the door seal form a convoluted series of bends that force any escaping microwave energy to contact the bends at a low angle of incidence; wherein each of the bends comprises an absorbent material associated therewith.

15. The seal of claim 14, wherein the convoluted series of bends comprises (a) the cavity seal comprising a first groove and a second groove, each of the first and second grooves comprising an absorbent material contained therein and (b) the door seal comprising inner groove and an outer groove, each of the inner grooves and outer grooves comprising an absorbent material contained therein.
